(19) United States
(12) Patent Application Publication
(10) Pub. No.: US 2009/0106078 A1
(43) Pub. Date: Apr. 23, 2009

(54) SYSTEM FOR SELECTING DEMANDS FOR AND SUPPLIES OF SUBCONTRACTING AND MATCHING

(76) Inventor: Jean-Matthieu Boris, Paris (FR)

Correspondence Address: YOUNG & THOMPSON, 209 Madison Street, Suite 500, ALEXANDRIA, VA, 22314, US

(21) Appl. No.: 12/090,877

(22) PCT Filed: Oct. 21, 2005
(86) PCT No.: PCT/FR05/02631

§ 371 Date: Sep. 29, 2008

(51) Int. Cl. G06Q 10/00; G06F 3/048

(52) U.S. Cl. 705/9; 715/843

(57) ABSTRACT

A system for selecting demands for and supplies of sub-contracting and matching of a user of the Internet or an equivalent network and one or more other users of the Internet or an equivalent network comprises the following stages:
a) Registering at least one sub-contracting demander by assigning him an identification;
b) Registering at least one sub-contracting supplier by assigning him an identification;
c) Recording at least one sub-contracting demand;
d) Recording at least one sub-contracting supply;
e) Comparing the digital supply and demand codes;
f) Selecting the identifications) of a supplier for the purpose of allowing coordination, whereby each sub-contracting demand is made in response to an open and evolving selection process allowing multiple choices per category, and each sub-contracting supply is made in response to a closed and sequential selection process that allows limited choices per category.

This invention relates to the field of industrial production by sub-contracting with selection and matching, for demands for and supplies of sub-contracting, of at least one user of the Internet or an equivalent network or an equivalent public network and of one or more other users of the Internet or an equivalent network or an equivalent public network.

Industrial production by sub-contracting requires extensive and varied technical knowledge and poses problems of qualification for finding a sub-contractor who has the necessary capabilities and technical skills to meet the demands for sub-contracting and to identify the one who will be the most advantageous supplier from the standpoint of the quality/cost ratio because of high expenses in equipment and personnel having a very low rate of return as regards the identification of technical skills, as well as the coordination of supply and demand.

Currently, firms that desire to sub-contract a party or certain elements of their production or that desire to buy components that are useful to their production encounter numerous difficulties for finding a sub-contractor who has the capabilities and technical skills required for meeting their demands: these firms are in general reduced to relying for this purpose on exchanges of correspondence, approaching individuals, and participation in professional trade shows.

The invention has as its object to eliminate these drawbacks of the known technology by proposing a new system and new means for selecting and matching demands for and supplies of sub-contracting, in which the expenses in equipment and personnel are considerably reduced, in particular because of the elimination of the need to produce multiple questionnaires intended for possible partners while increasing the field of investigation that can extend to all the firms over the entire world that are able to use the Internet or an equivalent network or an equivalent public network.

The document FR 2,811,103 describes a process for selecting and matching demands for and supplies of sub-contracting, comprising the following stages:
a) Registering at least one sub-contracting demander by assigning him an identification as a demander;
b) Registering at least one sub-contracting supplier by assigning him an identification as a supplier;
c) Recording at least one sub-contracting demand by coding it in digital form;
d) Recording at least one sub-contracting supply by coding it in digital form;
e) Comparing the digital supply and demand codes for the purpose of selecting the suppliers who meet a particular demand;
f) Selecting the identification(s) of the supplier meeting a particular demand for the purpose of allowing a coordination of supplier(s).

The document FR 2,811,103 also describes a computer program product that comprises program code instructions for implementing the stages of the process for selecting and matching demands for and supplies of sub-contracting, comprising the following stages:
a) Registering at least one sub-contracting demander by assigning him an identification as a demander;
b) Registering at least one sub-contracting supplier by assigning him an identification as a supplier;
c) Recording at least one sub-contracting demand by coding it in digital form;
d) Recording at least one sub-contracting supply by coding it in digital form;
e) Comparing the digital supply and demand codes for the purpose of selecting the suppliers who meet a particular demand;
f) Selecting the identification(s) of the supplier meeting a particular demand for the purpose of allowing a coordination of supplier(s), when said program is executed by a computer.

The document FR 2,811,103 finally describes a computer screen that is connected to the Internet comprising display means that are controlled by a computer program product that comprises program code instructions for executing stages of the process for selecting and matching demands for and supplies of sub-contracting, comprising the following stages:
a) Registering at least one sub-contracting demander by assigning him an identification as a demander;
b) Registering at least one sub-contracting supplier by assigning him an identification as a supplier;
c) Recording at least one sub-contracting demand by coding it in digital form;
d) Recording at least one sub-contracting supply by coding it in digital form;
e) Comparing the digital supply and demand codes for the purpose of selecting the suppliers who meet a particular demand;
f) Selecting the identification(s) of the supplier who meets a particular demand for the purpose of allowing a coordination of supplier(s), when said program is executed by a computer, and when said screen is connected to the Internet and remotely receives display instructions coming from said program product.

The techniques that are described by the document FR 2,811,103, however, do not take into account the difference between the definitions of demands for and supplies of sub-contracting: actually, the sub-contracting demander should specify very exactly all his production capabilities, whereas the sub-contracting supplier may have evolving needs for the part to be produced.

The invention has as its object to remedy the drawbacks of the known technology of the document FR 2,811,103 by proposing a new system and new means for selecting and matching demands for and supplies of sub-contracting, in which the definitions that are relative to the desired results are subjected by means of the Internet or an equivalent network in a different form to the sub-contracting demanders and to the sub-contracting suppliers.

The invention relates to a system for selecting demands for and supplies of subcontracting and matching of a user of the Internet or an equivalent network and one or more other users of the Internet or an equivalent network.

The invention also relates to a data support comprising at least one software portion that allows the execution of the system according to the invention for selecting demands for and supplies of sub-contracting and matching of a user of the Internet or an equivalent network and one or more other users of the Internet or an equivalent network.

The invention also relates to a nomenclature or taxonomy that relates to the results both sought by sub-contracting demanders and proposed by sub-contracting suppliers.

The nomenclature, or taxonomy, relative to the results sought by sub-contracting demanders, is submitted to them by means of the Internet or an equivalent network in matrix form.

The nomenclature, or taxonomy, relative to the results proposed by sub-contracting suppliers, is submitted to them by means of the Internet or an equivalent network in branching form.

The invention, finally, relates to a visual presentation of the computer screen connected to the Internet or an equivalent network that makes it possible to execute the system according to the invention for selection of demands for and supplies of sub-contracting and matching of a user of the Internet or an equivalent network and of one or more other users of the Internet or an equivalent network.

According to the invention, each sub-contracting demand is carried out in response to an open and evolving selection means that allows multiple choices per category, and each sub-contracting supply is carried out in response to a closed and sequential selection means that allows limited choices per category.

Preferably, each sub-contracting demand made in response to a means of open and evolving selection allowing multiple choices per category is made by selection in a set of matrices comprising preset keywords defined by a nomenclature, or taxonomy, relative to the results both sought by sub-contracting demanders and proposed by sub-contracting suppliers.

Also preferably, each sub-contracting demand should be accompanied by plans or drawings that are downloaded as an integral part of the demand on the Internet or any other similar network so as to make it possible for a possible supplier to better assess his ability to respond favorably to the demand.

Also preferably, each sub-contracting supply made in response to a closed and sequential selection means that allows limited choices per category is made by selecting from a set of drop-down menus that are arranged in branching form and that comprise a list of preset keywords defined by a nomenclature, or taxonomy, relative to the results both sought by sub-contracting demanders and proposed by sub-contracting suppliers.

The invention will be better understood owing to the following description provided by way of nonlimiting example with reference to the accompanying drawings, in which:

With reference to FIG. 1, a system according to the invention comprises successive stages of registering, recording, coding, comparing codes, and selecting.

In stage 1, a choice of languages is made to allow the execution of the system according to the invention in a language that is chosen from among a number of languages. In stage 2, which is an interrogation stage, a choice is to be made to determine the position of the one implementing the system:
Sub-contracting demander,
Or a sub-contracting supplier.

In the case of a sub-contracting demander, a registration-verification stage 3 is carried out: if the demander is already registered and does not wish to modify his registration identifications, stage 4 is skipped to go on to stage 5.

If the demander is not registered, a registration stage 4 in which a complete identification of the demander is made is carried out. This complete identification may correspond to the input of the corporate name and the trade name of the sub-contracting demander, one or more addresses for delivery or quality control or production, the zip code and country, the address of the e-mail and of the technical officer or the purchasing officer who manages the demander's sub-contracting demand. A connection code (“login”) and a password can be chosen or assigned automatically by the system. A re-entry of the password is generally requested to verify its validity.

This optional assignment of the connection code or the password can be replaced within the framework of the invention by any identification means, such as biological authentication by means of fingerprints, by reading the iris of the eye, or by an integrated chip card, combined with a means for verifying the authority of the supply manager within the firm that corresponds to the indicated corporate name.

After this registration stage 4, the system moves on to the activity identification stage 5.

This activity identification stage 5 consists in indicating the technical characteristics of the sub-contracting demand.

For this purpose, a set of matrices that comprises preset keywords defined by a nomenclature, or taxonomy, relative to the results both sought by sub-contracting demanders and proposed by sub-contracting suppliers, and referring only to technical characteristics of the sub-contracting sought by the ordering parties and able to be provided by the sub-contractors, is presented to the demander, in which he has only to check the boxes of the matrices corresponding to the production capabilities required of the sub-contractors to be able to meet his demand.

The demander can also load plans, detailed technical diagrams or other diagrams that explain the technical characteristics of the sub-contracting demand.

Then comes the stage 6 for digital coding of data input by the sub-contracting demander in stage 5, and optionally in preceding stages.

The rest of stages 3 to 6 can be carried out by being connected to the Internet or an equivalent network, but it can also be carried out locally on a computer that is not connected to the Internet or an equivalent network, so as to prepare the demand and to store it locally before circulating it on the Internet or an equivalent network.

In the case of a sub-contracting supplier, in stage 2, a choice is made that leads to a registration verification stage 10, then optionally to a registration stage 11 of the sub-contracting supplier, comprising data such as corporate name, trade name, one or more addresses, zip code, country, address of the e-mail and the name of the officer responsible for the sub-contracting supply. A connection code (“login”) and a password can be chosen or assigned automatically by the system. A re-entry of the password is generally requested to verify its validity.

This optional assignment of the connection code or the password can be replaced within the framework of the invention by any means of identification, such as biological authentication by means of fingerprints, by reading the iris of the eye, or by an integrated chip card, combined with a means for verifying the authority of the supply manager within the firm corresponding to the indicated corporate name. This registration stage 11 can be replaced by a verification of a registration already made; this registration stage 11 can, however, be repeated in the case of a modification of data corresponding to a preceding registration. After stage 11, a stage 12 for identification of the technical characteristics, logistical characteristics, geographic characteristics or other characteristics of the sub-contracting supplier is reached by indicating—in drop-down menus that comprise a list of preset keywords that refer to results of the sub-contracting sought by the ordering parties and able to be provided by the sub-contractors, arranged in branching form—a certain number of characteristics by simple operations that consist in checking or not checking the boxes that comprise the preset keywords presented in branching form.

After data input in stage 12, a stage 13 for digital coding of characteristics already performed is carried out to obtain a set of digital data corresponding to a digital coding of the sub-contracting supply proposed by the supplier.

A shaping in stage 14 of the digital coding carried out in stage 13 is then carried out in stage 15 to make possible a comparison of digital coding of the sub-contracting supply and demand.

This comparison in stage 1S of the digital coding carried out respectively in stage 6 for the sub-contracting supply and in stage 14 for the sub-contracting demand makes it possible to determine in an internal stage 16, i.e., not visually appearing to the sub-contracting supplier or to the sub-contracting demander, if the demand can be carried out by at least one sub-contractor.

If no sub-contractor can meet the demand, the system ends at a stage 17.

If at least one sub-contractor can meet the particular demand, the system continues in a stage 18 in which the various sub-contractors that are chosen are grouped on an e-mail distribution list.

The list of sub-contracting suppliers made automatically in stage 18 is not sent to the sub-contracting demanders.

On the contrary, the sub-contracting suppliers receive in their respective e-mail mailboxes 19 an indication according to which they should be connected by the Internet or an equivalent network to the system implementation site for identifying and reading electronic messages that may comprise files that correspond to the sub-contracting demands that may concern them.

These sub-contracting demands are each identified by a distinctive reference and can be downloaded by the suppliers that are interested by these demands.

If an interested supplier among a group of e-mail mailbox holders 19 desires to match up with the corresponding demander, he requests the e-mail address of this sub-contracting demander in stage 20 by indicating the identification reference of the corresponding demand, either immediately during the connection or during a subsequent connection.

This demand can only be met if—optionally outside of free promotion periods—the sub-contracting supplier is paid an amount that is set in advance by carrying out an online settlement, for example with a bank card or the equivalent, or, if he subscribes to a subscription that comprises the payment of a certain sum, the debiting of a certain amount each time the subcontracting supplier wants to know the coordinates of a demander whose demand he reads.

A counting 23 or another statistical verification operation of use of the system according to the invention or issuance of the e-mail address of the sub-contracting demander is implemented in response to a test 21 that indicates if the e-mail address of the demander is valid or present in the memory of the device for implementing the system according to the invention.

If, in the stage 21 for verification of the e-mail address of the demander, the e-mail address of this demander is unavailable or not valid, the system according to the invention ends in stage 22 without the statistical operation 23 being carried out. The advantages of the statistical operation 23 are to make it possible to monitor good operation of the device and the system according to the invention, to measure the technical parameters of the implementation of the system, and optionally to establish a billing that takes into account the frequency of use of the system according to the invention.

Thus, the system according to the invention makes it possible for a sub-contracting demander to obtain automatically supplies of sub-contracting that correspond exactly to a specific and particular sub-contracting demand.

This matching is carried out advantageously in an entirely digital form by the Internet or an equivalent network preferably by exchanging data by e-mail between sub-contracting demander and supplier, but it optionally can take any other forms upon the initiative of one or both parties.

Because the coordination is carried out automatically by e-mail or exchange of identification, the fees for drafting, typing, and sending numerous copies of demands for and supplies of sub-contracting are eliminated, which also contributes to a significant savings in equipment and individuals.

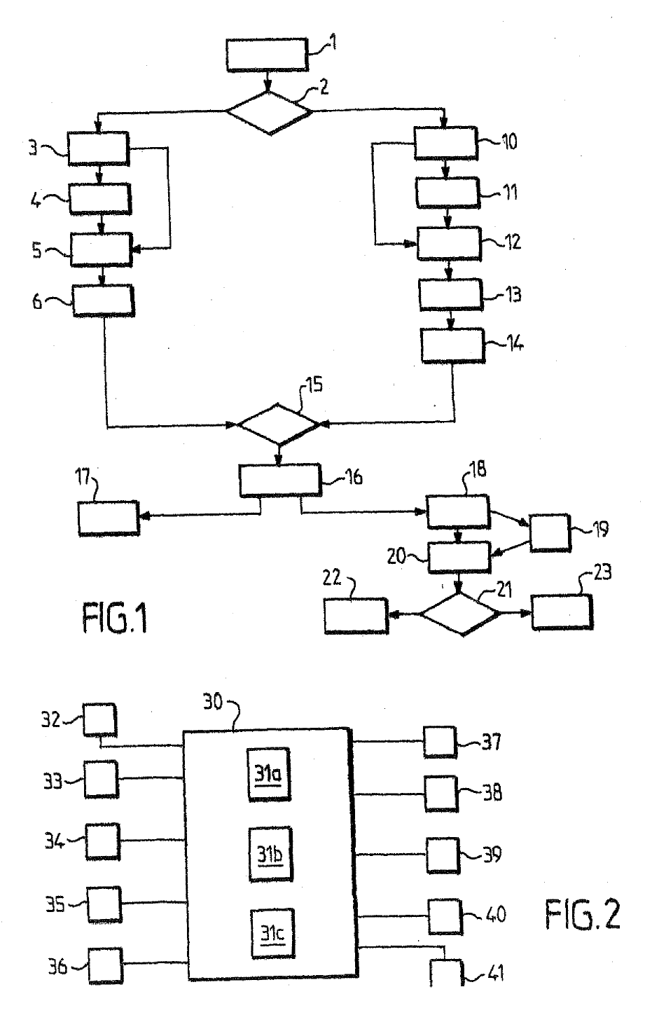

With reference to FIG. 2, a software or material firewall 30 isolates one or more computers 31a, 31b, 31c that contain stores or media that contain at least one portion of a software program for implementing a system of the type that is described in FIG. 1.

The software for implementing the system according to the invention advantageously comprises a set of matrices for the demands for sub-contracting, drop-down menus and/or directed branching for the supplies of sub-contracting, registration, recording, coding and the coordination by e-mail to perform the stages of the system described in FIG. 1.

Preferably, the data exchange, the inputs and the outputs of data and the transmissions by mail are carried out electronically via the Internet or an equivalent network, so as to connect one or more computers of sub-contracting demanders 32, 33, 34, 35, 36 to one or more computers of sub-contracting suppliers 37, 38, 39, 40, 41.

The implementation of the system according to the invention makes it possible to carry out the demands for and supplies of sub-contracting automatically and with smooth formulation so as to select, after digital coding, the supplies that meet a particular demand for the purpose of making possible a transmission of a supply to a demander that corresponds to a so-called particular demand. This selection can be permanent or episodic, as sought by the demander or the supplier of sub-contracting subscribed for the use of the system according to the invention.

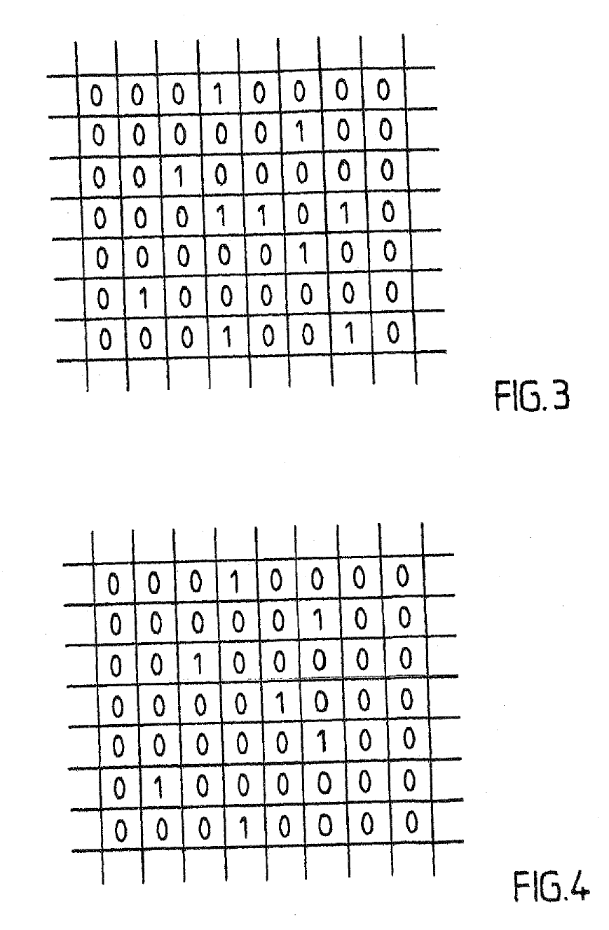

With reference to FIG. 3, a preferably binary digital coding, preferably used for the implementation of the system according to the invention in the case of sub-contracting demands, corresponds to a matrix with multiple rows, in which the successive lines can all be checked simultaneously and correspond to an increasing precision of the activity corresponding to the sub-contracting supply or demand.

By way of nonlimiting example, a number 1 of the first line may correspond to an activity of the electronic domain.

A number 1 in the second line may correspond to the assembly of units and subunits. A number 1 in the third line may correspond to the assembly of electromechanical units. The three numbers 1 in the fourth line may correspond to various methods of assembly: welding, brazing, mechanical assembly by rivets, screwing or deformation; assembly by gluing, by chemical bonding or by pressurized adhesion.

A number 1 in the fifth line may correspond to a quality control by means of radiological or ultrasonic examinations.

A number 1 in the sixth line may correspond to an operational test of the assembly by means of a tester or a similar machine.

A number 1 in the last line may correspond to means of environmental tests, means of electromagnetic tests for verifying the electromagnetic compatibility of the unit, or a corresponding certification of the production.

The digital coding carried out may, instead of being shown in matrix form, be arranged in a concatenated form, without thereby exceeding the scope of this invention.

With reference to FIG. 4, a preferably binary digital coding that can be used for the implementation of the system according to the invention in the case of sub-contracting supplies corresponds to a matrix with multiple rows, in which a single successive line can be checked and corresponds to an increasing precision of the activity that corresponds to the sub-contracting supply or demand.

By way of example, the number 1 of the first line may correspond to an activity of the electronic domain.

The number 1 in the second line may correspond to the assembly of units and subunits. The number 1 in the third line may correspond to the assembly of electromechanical units. The three numbers 1 in the fourth line may correspond to various assembly methods: welding, brazing, mechanical assembly by rivets, screwing or deformation; assembly by gluing, by chemical bonding or by pressurized adhesion.

The number 1 in the fifth line may correspond to a quality control by means of radiological or ultrasonic examinations.

The number 1 in the sixth line may correspond to an operational test of the assembly by means of a similar tester or machine.

The number 1 in the last line may correspond to environmental test means, electromagnetic test means to verify the electromagnetic compatibility of the unit or a corresponding certification of the production.

The digital coding that is carried out can, instead of being shown in matrix form, be arranged in a concatenated form, without thereby exceeding the scope of this invention.

In an embodiment of the invention that is not shown and that can be used for the implementation of the system according to the invention in the case of supplies of sub-contracting corresponds to drop-down menus with multiple criteria; the display screen comprises a zone for displaying second and third criteria.

The zone for displaying the names of the second and third criteria can be arranged on both sides of the zone for displaying the values of the second and third criteria.

Advantageously, the system comprises a means for selecting the second and third criteria from among a list of criteria.

In one embodiment of the invention, one calculation unit comprises a storage table that combines with each type of product an instruction for displaying a suitable window. Advantageously, the calculation unit comprises a means for classifying the programs for production at least based on a fourth criterion and a fifth criterion.

The system makes it possible to supply an entire bank of preprogrammed criteria with the possibility of adapting the result to its criteria by modifying a production setting, without recreating new selection programs, without having to know, either by recording or by consulting a manual, the criteria to be modified and the associated parameters, in clear language, directly accessible through formulation from preset keywords defined by a nomenclature, or taxonomy, according to the invention.

The final criteria that the user can modify are in particular an external criterion, for example of appearance, and an internal criterion, for example logistical.

The display screen can be of the LCD type, allowing the display of data in several configurable languages, the control of the modifications being performed by one or two keys providing access to menus and to the choices posted to the screen.

The final criteria are defined according to the family, the product, and the type of production and can be displayed by means of a bar graph that is combined with a designation of the criterion.

The invention that is described with reference to particular embodiments is not limited in any way, but on the contrary covers all modifications of shapes and all variant embodiments within the scope and the spirit of the invention; thus all kinds of communication networks can be used, making possible a communication analogous to the one obtained by the Internet or an equivalent network.

In addition, the invention extends to all forms of digital coding that makes possible a comparison of the digital codes of a sub-contracting demand to one or more supplies of sub-contracting, with a view to selecting the suppliers that are satisfactory to each demand.

Preferably, the system and the device according to the invention communicate the data that allow the matching of the demanders for and the suppliers of sub-contracting only after processing and digital coding of the data provided, comparison of the digital coding, and selection of the individuals to be brought together.

According to a variant of the invention that is not shown, a demander and a supplier are automatically brought together by exchange of identification or e-mail addresses; in this case, an automatic generation of electronic messages that comprise their addresses is provided between stage 20 and stage 21 of FIG. 1.

1. System for selecting demands for and supplies of sub-contracting and matching a user of the Internet or an equivalent network and one or more other users of the Internet or an equivalent network, comprising the following stages:
a) Registering at least one subcontracting demander by assigning him an identification as a demander;
b) Registering at least one sub-contracting supplier by assigning him an identification as a supplier;
c) Recording at least one sub-contracting demand;
d) Recording at least one sub-contracting supply;
e) Comparing the digital supply and demand codes;
f) Selecting the identification(s) meeting a particular demand for the purpose of allowing a coordination;
characterized in that each sub-contracting demand is made in response to an open and evolving selection means allowing multiple choices per category and in that each sub-contracting supply is made in response to the closed and sequential selection means that allows limited choices per category.

2. System according to claim 1, wherein each sub-contracting demand that is made in response to an open and evolving selection means that allows multiple choices per category is carried out by selection in a set of matrices comprising preset keywords defined by a nomenclature, or taxonomy, relative to the results both sought by sub-contracting demanders and proposed by the sub-contracting suppliers.

3. System according to claim 1, wherein each sub-contracting supply that is made in response to a closed and sequential selection means that allows limited choices per category is carried out by selection in a set of drop-down menus that are arranged in branching form and that comprise a list of preset keywords defined by a nomenclature, or taxonomy, relative to the results both sought by sub-contracting demanders and proposed by sub-contracting suppliers.

4. System according to claim 1, characterized by a stage for transmission (20) by electronic mail from the e-mail address of the sub-contracting demander corresponding to a particular demand.

5. System according to claim 1, wherein a sub-contracting demander and a sub-contracting supplier are automatically brought together.

6. System according to claim 5, wherein the automatic connection is carried out by exchange (23) of identifications or e-mail addresses.

7. System according to claim 1, wherein the implementation of the system is carried out by use of at least one software program that comprises a set of drop-down menus, and/or matrices and/or directed branching for registering, recording, coding and coordination by e-mail.

8. System according to claim 7, wherein the transmission of the data inputs and outputs required by said software is carried out by the Internet or an equivalent network.

9. Computer program product comprising program code instructions for executing the stages of the system according to claim 1, when said program is executed by a computer.

10. Computer screen that is connected to the Internet or an equivalent network that comprises display means that are controlled by a computer program product according to claim 9, when said screen is connected to the Internet or an equivalent network and remotely receives display instructions coming from said program product.

11. System according to claim 2, wherein each sub-contracting supply that is made in response to a closed and sequential selection means that allows limited choices per category is carried out by selection in a set of drop-down menus that are arranged in branching form and that comprise a list of preset keywords defined by a nomenclature, or taxonomy, relative to the results both sought by sub-contracting demanders and proposed by sub-contracting suppliers.

12. System according to claim 2, wherein the implementation of the system is carried out by use of at least one software program that comprises a set of drop-down menus, and/or matrices and/or directed branching for registering, recording, coding and coordination by e-mail.

13. System according to claim 3, wherein the implementation of the system is carried out by use of at least one software program that comprises a set of drop-down menus, and/or matrices and/or directed branching for registering, recording, coding and coordination by e-mail.

14. System according to claim 4, wherein the implementation of the system is carried out by use of at least one software program that comprises a set of drop-down menus, and/or matrices and/or directed branching for registering, recording, coding and coordination by e-mail.

15. System according to claim 5, wherein the implementation of the system is carried out by use of at least one software program that comprises a set of drop-down menus, and/or matrices and/or directed branching for registering, recording, coding and coordination by e-mail.

16. System according to claim 6, wherein the implementation of the system is carried out by use of at least one software program that comprises a set of drop-down menus, and/or matrices and/or directed branching for registering, recording, coding and coordination by e-mail.
